(19) United States
(12) Patent Application Publication
(10) Pub. No.: US 2007/0163831 A1
(43) Pub. Date: Jul. 19, 2007

(54) Radial engine powered motorcycle

(76) Inventor: Barry Stevens, Arlington, TX (US)

Correspondence Address: LARS D. JENSEN, 5720 FOREST BEND DR, SUITE 103, ARLINGTON, TX, 76017, US

(21) Appl. No.: 11/334,327

(22) Filed: Jan. 18, 2006

(51) Int. Cl. B62K 11/00

(52) U.S. Cl. 180/219

(57) ABSTRACT

A motorcycle powered by a radial internal combustion engine, particularly optimized by having cylinders of unequal angle, length, or diameter.

### FIELD

The present invention relates in general to internal combustion powered motorcycles, and more particularly to an innovative means of powering a motorcycle using a radial engine.

### BACKGROUND

Currently, motorcycles powered by internal combustion engines have a single cylinder or multiple cylinders in a vee, opposing, or inline configuration. In early years, the Millet Motorcycle made in 1892 had a radial engine turning within the rear wheel. The Megola Motorcycle made in 1921 and the Killinger & Freund Motorcycle made in 1938, both had a radial engine turning within the front wheel. Radial engines have been used to power aircraft. The inventor defines a radial engine as one in which every angle in degrees between adjacent cylinders is less than 180.

A PRIOR ART engine having a vee shape is shown in FIG. 1 having adjacent cylinder angles noted by reference letters X and Y. As herein defined by the inventor, this PRIOR ART engine is not a radial engine because angle Y is not less than 180 degrees.

### SUMMARY

Used in a motorcycle, a radial engine has several advantages over prior art design. Aesthetically, the radial engine better fits the frame space. The airflow over more cylinders having more surface area, makes cooling more efficient. Additionally, the radial engine is more rugged and resistant to damage. Furthermore, the power and efficiency of the radial engine can be optimized by selection of particular cylinder angles, lengths, and diameters.

These and other features, aspects, and advantages of the present invention will become better understood with regard to the following description, appended claims, and accompanying drawings.

### BRIEF DESCRIPTION OF THE DRAWINGS

The following drawings describe a PRIOR ART engine:

FIG. 1 is a side view of a PRIOR ART engine having cylinders in a vee shape.

The following drawings describe the present invention:

FIG. 2 is a side view of a motorcycle according to the present invention;

FIG. 3 is a side view of a motorcycle according to the present invention;

FIG. 4 is a side view of a motorcycle according to the present invention; and

FIG. 5 is an enlarged view of the rotary engine from FIG. 4.

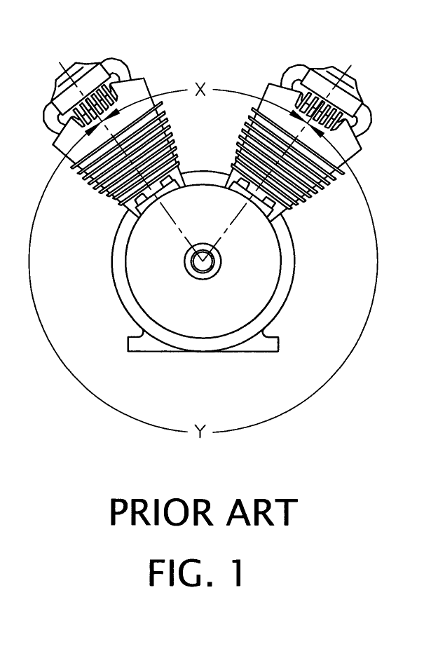

### DETAILED DESCRIPTION OF THE INVENTION

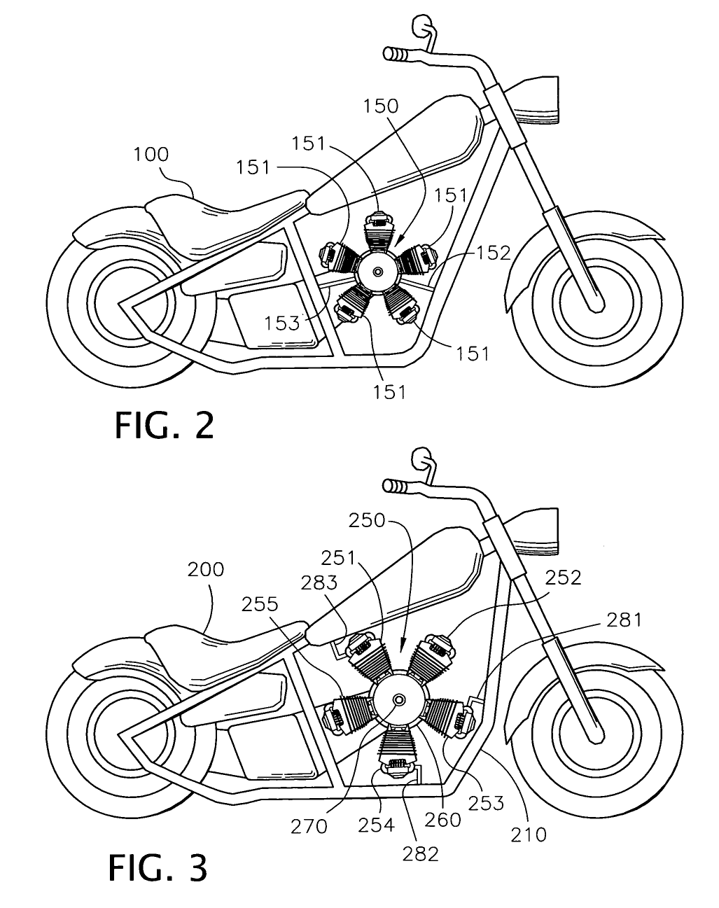

FIG. 2 shows a first embodiment of the present invention having a radial engine 150 mounted within the frame of a motorcycle 100. The engine has cylinders 151 and is supported on motor mounts 152 and 153. For the sake of clarity, some parts such as intake and exhaust manifolds are not shown. Power connection and transmission are shown in the rear. FIG. 2 shows how the radial engine makes efficient use of the limited space within the motorcycle frame.

FIG. 3 shows a second embodiment of the present invention having a radial engine 250 mounted within the frame of a motorcycle 200, on motor mounts 281, 282, and 283. The engine has cylinders 251, 252, 253, 254, and 255 attached to a block 260 and located radially about a crankshaft 270. For the sake of clarity, some parts such as intake and exhaust manifolds are not shown. Power connection and transmission are shown in the rear. Each of the cylinders is identical in size and shape and the angles between adjacent cylinders are identical. This radial engine is similar but larger than previously shown radial engine 150. This is possible, because it is rotated differently and a motorcycle frame 210 is bent to permit space for cylinder 253. Thus, the inventor envisions many versions of the present invention having three or more cylinders and fitted particularly to suit cooperatively modified motorcycle frames.

The first and second embodiments of the present invention have identical cylinders, wherein adjacent cylinders are located at an angle in degrees equal to 360 divided by the number of cylinders.

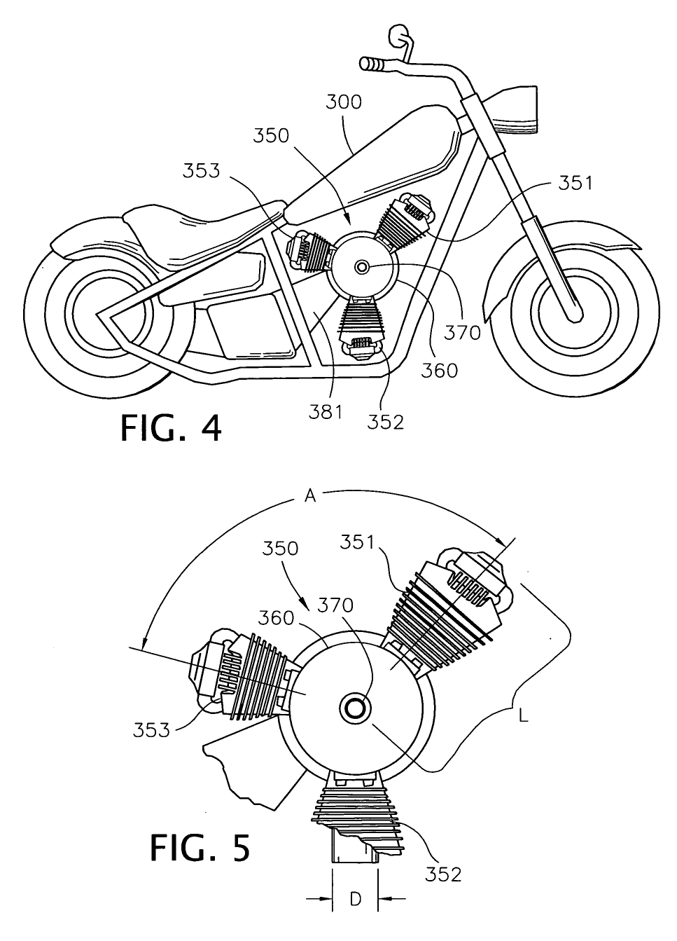

FIG. 4 shows a third embodiment of the present invention having a radial engine 350 mounted within the frame of a motorcycle 300, on a motor mount 381. The engine has cylinders 351, 352, and 353 attached to a block 360 and located radially about a crankshaft 370. For the sake of clarity, some parts such as intake and exhaust manifolds are not shown. Power connection and transmission are shown in the rear. The three cylinders shown are individually modified and located for an optimal fit in the motorcycle.

FIG. 5 shows an enlarged view of the radial engine 350 from FIG. 4. Now it can be seen in this third embodiment of the present invention, that the angles between adjacent cylinders are unequal. For example, the angle between cylinders 351 and 353 (noted by reference letter A) is larger than that angle between cylinders 352 and 353, and different also from that angle between cylinders 351 and 352. The inventor further envisions the third embodiment of the present invention encompassing many versions of a radial engine wherein an angle in degrees between any two adjacent cylinders in degrees is not equal to 360 divided by the number of cylinders.

FIG. 5 also shows cylinder 351 having a certain length (noted by reference letter L) which is longer than that of cylinder 353. The inventor further envisions the third embodiment of the present invention encompassing many versions of a radial engine wherein any two of the cylinders have unequal lengths.

FIG. 5 also reveals the interior of cylinder 352 having a certain diameter (noted by reference letter D) which is larger than that of cylinder 353. The inventor further envisions the third embodiment of the present invention encompassing many versions of a radial engine wherein any two of the cylinders have unequal diameters.

While these embodiments have specifically shown five and three cylinders by way of example, the inventor envisions all embodiments of the present invention working equally well having a number of cylinders, wherein the number is three or more.

A radial engine has been disclosed secured in a motorcycle by motor mounts attached to the block. However, the present invention will work equally well having a radial engine secured as disclosed by motor mounts attached to cylinders, or any combination of either type mount.

For the sake of brevity, many well understood components of an internal combustion engine have not been shown, but are needed to operate. Parts such as cams, valves, sparkplugs, pistons and connecting rods are required.

While the above descriptions and embodiments contain many specific features by way of example, they should not be construed as limitations on the scope of the invention. Many other variations are possible within the scope of the following claims.

I claim:

1. A motorcycle comprising an engine having a crankshaft turning in a block, said engine comprising:
A number of cylinders, wherein the number is three or more, wherein the cylinders are attached to the block and located radially about the crankshaft, and wherein every angle in degrees between adjacent cylinders is equal to 360 divided by the number.

2. A motorcycle comprising an engine having a crankshaft turning in a block, said engine comprising:
A number of cylinders, wherein the number is three or more, wherein the cylinders are attached to the block and located radially about the crankshaft, and wherein an angle in degrees between any two adjacent cylinders in degrees is not equal to 360 divided by the number,
wherein every angle in degrees between adjacent cylinders is less than 180.

3. A motorcycle comprising an engine having a crankshaft turning in a block, said engine comprising:
A number of cylinders each having a length, wherein the number is three or more, wherein the cylinders are attached to the block and located radially about the crankshaft, and wherein any two of the lengths are unequal,
wherein every angle in degrees between adjacent cylinders is less than 180.

4. A motorcycle comprising an engine having a crankshaft turning in a block, said engine comprising:
A number of cylinders each having a diameter, wherein the number is three or more, wherein the cylinders are attached to the block and located radially about the crankshaft, and wherein any two of the diameters are unequal,
wherein every angle in degrees between adjacent cylinders is less than 180.
